(19) United States
(12) Patent Application Publication
(10) Pub. No.: US 2017/0021339 A1
(43) Pub. Date: Jan. 26, 2017

(54) METHODS OF MAKING AND USING LAYERED COBALT NANO-CATALYSTS

(71) Applicant: The University of Notre Dame du Lac, Notre Dame, IN (US)

(72) Inventors: Chongzheng Na, Lubbock, TX (US); Hanyu Ma, Notre Dame, IN (US); Haitao Wang, Lubbock, TX (US)

(73) Assignee: The University of Notre Dame du Lac, Notre Dame, IN (US)

(21) Appl. No.: 15/202,313

(22) Filed: Jul. 5, 2016

Related U.S. Application Data
(60) Provisional application No. 62/188,329, filed on Jul. 2, 2015.

(51) Int. Cl. B01J 23/78; C02F 1/72; B01J 23/00

(52) U.S. Cl. CPC B01J 23/78; B01J 23/002; C02F 1/725; B01J 2523/00

(57) ABSTRACT

A method of making LDO-Co nanoparticles is described herein. A method of using LDO-Co nanoparticles, particularly in the treatment of wastewater, is described herein.

### CROSS-REFERENCE TO RELATED APPLICATIONS

This application claims the benefit of, and priority to, U.S. Provisional Application Ser. No. 62/188,329, filed Jul. 2, 2015, which is incorporated herein in its entirety.

### STATEMENT REGARDING FEDERALLY SPONSORED RESEARCH OR DEVELOPMENT

This invention was made in part with Government support under grant no. CFP-12-3923, awarded by the US Department of Energy's Office of Nuclear Energy Nuclear Energy University Programs; and under grant no. CBET-1033848 from the National Science Foundation's Environmental Engineering Program. The U.S. government has certain rights in the invention.

### BACKGROUND

Field

The present disclosure provides layered double oxide (LDO) supported-Co nanoparticles and methods of making and using the same.

Description of Related Art

Replacing precious noble-metal catalysts with non-precious metal ones is a well-recognized strategy for reducing the cost of catalytic reactions such as water treatment. The implementation of this strategy is, however, challenging. To reduce the cost by using non-precious metal catalysts, the reactivity ratio between non-precious and precious metal catalysts must exceed their price ratio. An important challenge, therefore, for developing catalysts for water treatment and environmental remediation is to reduce the cost associated with catalyst fabrication and restocking.

One potential solution is replacing the commonly used but expensive 4d and 5d precious noble metal catalysts such as palladium (Pd) and platinum (Pt) with inexpensive 3d non-precious metal catalysts such as cobalt (Co) and nickel (Ni). This solution, however, can be less than ideal. Because non-precious metal catalysts, including Co and Ni are usually much less reactive than those made of precious metals, a financial gain can only be made when the ratio of their reactivities exceeds the ratio of their prices. Reaching this cost parity is, however, challenging, even in spite of recent advances in the design and synthesis of nano-sized catalysts. According to the London Metal Exchange, cobalt and palladium have a price ratio of approximately 1:750. According to their reactivities in catalyzing the model reaction of p-nitrophenol reduction by borohydride, the ratio of their mass-normalized reactivities is less than 1:1000, suggesting a discouraging economic loss if cobalt is used to replace palladium to remediate p-nitrophenol.

The mass-normalized reactivity of nano-catalysts is directly correlated to their stability against aggregation. To prevent aggregation, palladium nanoparticles have been prepared using a variety of stabilizing agents, including dendrimers, peptides, alumina (Al₂O₃) particles, and carbon nanotubes. For the catalyzed reduction of p-nitrophenol by borohydride, the mass-normalized rate constants of palladium catalysts range over nearly 4 orders of magnitude from k=1.0 to 6.9×10³ min⁻¹ g⁻¹ L, with the most active palladium nanoparticles created under the stabilization of dendrimers. In comparison, only limited efforts have been given to finding the appropriate stabilizers for nanoparticles made of non-precious metals such as cobalt. Examples of stabilizers for cobalt nanoparticles include reduced graphene oxide, hydrogel, and silica (SiO₂) cage, yielding k=0.82-30.8 min⁻¹ g⁻¹ L in the catalyzed reduction of p-nitrophenol by borohydride. Compared to unsupported cobalt nanoparticles, only 2 orders of magnitude of improvement have been achieved using these stabilizing supports, much lower than the improvement made by stabilizing agents for palladium nano-catalysts.

Well-dispersed cobalt nanoparticles can be made by the topotactic transformation of layered double hydroxide (LDH) nanodisks. It is worth noting, however, that synthesizing cobalt nanoparticles with diameters around and under 10 nm is still challenging even when stabilizing surfactants such as poly(vinyl pyrrolidone) are used in synthesis. The ability to synthesize exposed cobalt nanoparticles in this size range is particularly advantageous because although stabilizing surfactants can help control nanoparticle size and shape, they can also block the access to active surface sites and lead to reduced reactivity.

What is needed, therefore, is surfactant-free, non-aggregating cobalt-containing nanoparticles.

### SUMMARY

The description provides a method of making LDO-Co, comprising reacting LDH with Co. The description further provides a method of using LDO-Co to remove p-nitrophenol from water.

Other objects and features will be in part apparent and in part pointed out hereinafter.

### BRIEF DESCRIPTION OF THE DRAWINGS

Those of skill in the art will understand that the drawings, described below, are illustrative only. The drawings are not intended to limit the scope of the claimed invention in any way.

FIG. 1. Synthesis and characterization of layered double oxide (LDO)-supported cobalt nano-catalysts. (a) Schematic of critical steps: I. Hydrothermal synthesis of layered double hydroxide (LDH) and II. Conversion of LDH to nanoparticle-decorated LDO. (b) Scanning electron micrograph of LDH. (c, d) Atomic force micrographs of LDH and LDO nanodisks. (e) Transmission electron micrograph of cobalt-decorated LDO. (f) Powder X-ray diffraction patterns of LDH and LDO, reflections corresponding to hydrotalcite (JCPDS 70-2151) and spinel (JCPDS 21-1152) structures. Horizontal scale bars: b, 10 μm; c, 2 μm; d and e, 50 nm.

FIG. 2: Cobalt and cobalt oxide nanoparticles affixed on layered double oxide (LDO) nanodisks. (a, b, c) High-resolution transmission micrographs (HRTEM), fast Fourier transformation (FFT), and molecular model of the metallic core for partially oxidized nanoparticles. (d, e, HRTEM, FFT, and molecular model of cobalt oxide (Co₃O₄) for completely oxidized cobalt nanoparticles. (g, h, i) HRTEM, FFT, and molecular model of the LDO support. White circles mark the areas in HRTEM where FFT analyses are performed. Sample orientation [direction perpendicular to paper, direction pointing upward within paper]:Co, [001,010]; Co₃O₄, [111,011]; LDO, [111,]. Scale bars: a, d, g, 10 nm; b, e, h, 5 nm⁻¹.

FIG. 3. Dependence of nanoparticle size on cobalt molar percentage (θ). (a) Increase of the diameter of Co nanoparticles with θ=Co/(Co+Al+Mg). (b) Continuous film formed at θ=51%. The solid and dashed curves in a are the least-square fit and 90% confidence intervals of d=χθ^{1/3} (R²=0.99). Scale bars: 50 nm.

FIG. 4. Catalytic reactivity of LDO-supported cobalt nanoparticles. (a) Reduction of p-nitrophenol (PNP; solid curve) to p-aminophenol (dashed curve). (b) Pseudo first order kinetics with an induction time (squares: with LDO-Co; circles: without LDO-Co). The line is a linear fit to Equation 1. LDO-Co: Co molar percentage, 15(±1)%.

FIG. 5. Dependence of (a) pseudo first order rate constant and (b) induction time on cobalt molar percentage. The solid curves are least-square regressions of k and tᵢ to θ^{2/3} (R²=0.95 and 0.99) for θ≦28%. The dashed lines brackets 90% confidence intervals. The dotted lines connect the remaining data points.

FIG. 6. Mass-averaged pseudo first order rate constant (kₘ) of LDO-Co-catalyzed reduction of p-nitrophenol by borohydride. (a) Dependence of kₘ on cobalt molar percentage θ. (b) Comparisons of kₘ values for LDO-Co (circles) with those for other cobalt catalysts (squares) and various support-stabilized palladium nanoparticles (diamonds), as a function of initial p-nitrophenol concentration Cₒ. The solid curves in a and b are least-squares fits to the exponential function (R²=0.97) and the Langmuir-Hinshelwood model of Equation 2 (R²=0.98), respectively. The dash lines in a are linear fits.

FIG. 7. Prevention of nanoparticle aggregation by affixing cobalt nanoparticles on LDO via thermal phase transformation. (a) Comparison of reactivity, as expressed in the ratio of the rate constant obtained from p-nitrophenol reduction in each reuse to the rate constant obtained in the pristine use (k/k₀), between cobalt affixed on LDO (LDO-Co; circles) and cobalt loosely attached to LDO (LDO-Co*; squares). (b, c) Transmission electron micrographs (TEMs) of LDO-Co before and after reaction. (d) TEM of LDO-Co* before reaction. (e, f) TEM of LDO-Co* after reaction. Scale bars: b and c, 20 nm; d and e, 40 nm; f, 500 nm.

FIG. 8. Reduction of p-nitrophenol by formate catalyzed by LDO-supported cobalt nanoparticles. Symbols: circle, no LDO-Co; squares, LDO-Co. The solid line is a linear fit to Equation 1. The horizontal dash line represents an average. Experimental conditions: LDO-Co, 0.1 g L⁻¹; cobalt molar percentage, 28%; nanoparticle diameter, (±4.9) nm; p-nitrophenol, 0.2 mM; sodium formate, 50 mM.

FIG. 9. Heteroepitaxial fixation of cobalt nanoparticles on the spinel LDO support. (a, b, c) Transmission electron micrograph, fast Fourier transformation, and molecular model of a Co@Co₃O₄ core-shell nanoparticle on top of LDO. (d) Molecular model of heteroepitaxial stacking. Scale bar: a, 10 nm.

### DETAILED DESCRIPTION

The present disclosure is based, at least in part, on the observation that LDO-Co nanodisks serve as a useful catalyst for the reduction of p-nitrophenol, and that such a feature can be useful in the remediation and treatment of wastewater. Accordingly, disclosed herein are such LDO-Co nanodiscs, methods of making LDO-Co nanodiscs, and methods of using LDO-Co nanodiscs.

The present disclosure provides a method of making layered double oxide (LDO) particles. In one aspect, the LDO-Co particles comprise cobalt. The cobalt can be dispersed on one or both surfaces of the LDO. Any or all of the LDH, LDO, or LDO-Co can be a nanoparticle. The method of making LDO-Co nanoparticles can comprise reacting a solution comprising cobalt with layered double hydroxide (LDH). In some embodiments, the cobalt in the solution comprising cobalt can be provided as cobalt nitrate (Co(NO₃)₂). In some embodiments, the solution comprising cobalt can further comprise at least one of urea (CO(NH₂)₂), aluminum nitrate (Al(NO₃)₃), and magnesium nitrate (Mg(NO₃)₂). In some embodiments, the cobalt nitrate, aluminum nitrate, and magnesium nitrate are provided at a molar ratio of about 2 magnesium nitrate:2 cobalt nitrate:1 aluminum nitrate. In some embodiments, the cobalt nitrate, aluminum nitrate, and magnesium nitrate are provided at a molar ratio of 2 magnesium nitrate:2 cobalt nitrate:1 aluminum nitrate. In some embodiments, the molar percentage of cobalt relative to all metals (Θ) is between 0.1 and 67%. In one embodiment, Θ is, or is about, 28%.

In some embodiments, reacting comprises a step of placing a solution comprising cobalt in a sealed container with LDH. A sealed container can be any container which is closed to the atmosphere. A container which is closed to the atmosphere does not have to be physically closed, but rather can be sealed off through use of pressure from outside the container. The container can be of any material which does not interfere with the reaction of LDH and Co. In one embodiment, the material of the container can be a quartz tube.

In some embodiments, reacting comprises a step of heating the solution comprising cobalt and LDH to a temperature sufficient to cause reaction of the LDH and the Co. In some embodiments, that sufficient temperature can be about 600° C. In some embodiments, reacting comprises heating the solution comprising cobalt and LDH to a temperature of 600° C. In some embodiments, heating the solution takes place under an inert atmosphere. An inert atmosphere can be any atmosphere in which undesired reactions do not take place. For example, an inert atmosphere can be argon gas.

In some embodiments, reacting comprises a step of thermal phase transformation. The thermal phase transformation can take place in a sealed container. The thermal phase transformation can, in some embodiments, take place under a hydrogen gas atmosphere. The hydrogen gas atmosphere can be provided in any way that enables the thermal phase transformation to take place. For example, the hydrogen gas atmosphere can be provided at a rate of about 50 sccm. The hydrogen gas atmosphere can be provided at a rate of 50 sccm. The thermal phase transformation can be allowed to proceed for any length of time that allows the transformation to occur. In some embodiments, the thermal phase transformation can be allowed to proceed for 20 minutes, or for about 20 minutes.

In some embodiments, the disclosure provides a method of purifying, remediating, or cleaning water. The water can be any water which requires such treatment, including, but not limited to wastewater. In particular, the water requiring treatment can comprise p-nitrophenol. In some embodiments, the method of purifying water comprises contacting layered double oxide (LDO) comprising cobalt (LDO-Co) with water comprising p-nitrophenol (PNP). In some embodiments, the method further comprises mixing the LDO-Co with sodium borohydride (NaBH₄). In some embodiments, the method comprises reducing oxidized LDO-Co to metallic cobalt.

### DEFINITIONS

The following definitions provide a clear and consistent understanding of the following Specification and Claims. As used herein, the recited terms have the following meanings. All other terms and phrases used herein have the ordinary meanings that one of skill in the art would understand.

References in the specification to “one embodiment”, “an embodiment”, etc., indicate that the embodiment described can include a particular aspect, feature, structure, or characteristic, but not every embodiment necessarily includes that aspect, feature, structure, or characteristic. Moreover, such phrases can, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims can be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

The term “about” can refer to a variation of 5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percentages, proximate to the recited range that are equivalent in terms of the functionality of the individual ingredient, the composition, or the embodiment. The term about can also modify the end-points of a recited range as discuss above in this paragraph.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into subranges as discussed above. In the same manner, all ratios recited herein also include all sub ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group.

Additionally, for all purposes, the invention encompasses not only the main group, but also the main group absent one or more of the group members. The invention therefore envisages the explicit exclusion of any one or more of members of a recited group. Accordingly, provisos can apply to any of the disclosed categories or embodiments whereby any one or more of the recited elements, species, or embodiments, can be excluded from such categories or embodiments, for example, for use in an explicit negative limitation.

### LDH and LDO

Well-dispersed cobalt nanoparticles can be made by the topotactic transformation of layered double hydroxide (LDH) nanodisks. Layered double hydroxide (LDH) is a group of pseudo two-dimensional crystals having a structure similar to hydrotalcite (Mg₆Al₂CO₃(OH)16.4(H₂O)). This structure consists of alternating layers of metal oxides and intercalated water and anions. The disks often have a nominal diameter of micrometers but a thickness of only tens of nanometers. Cobalt has an ionic radius similar to that of magnesium; therefore, Co-containing LDH can be readily prepared by replacing part of magnesium with cobalt. LDH is then calcined in the presence of hydrogen (H₂) gas above 600° C., which separates Co from LDH and reduces it to the metallic nanoparticles. The calcination also transforms LDH to layered double oxide (LDO) with a spinel (MgAl₂O₄) structure by removing intercalated water and carbonate anions. Although spinel does not have a layered structure, because the platy morphology of LDH is largely preserved during calcination, the LDH derivative is often referred to as layered double oxide or LDO.

### LDO-Co

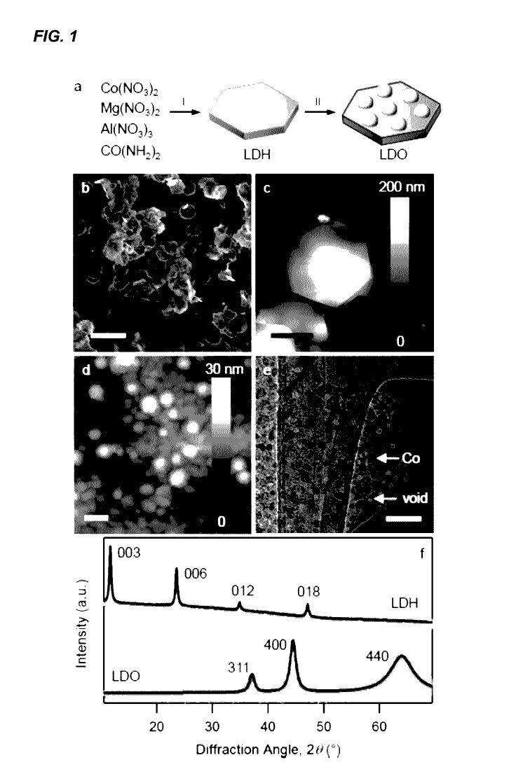

The present disclosure provides layered double oxide (LDO) supported-Co nanoparticles (see, eg, FIG. 1a), and methods of making and using the same. LDO-supported Co nanoparticles (LDO-Co) have been shown to be active in catalyzing hydrogenation reactions, steam reforming, aldol condensation, thermal decomposition, oxidation and combustion, and carbon nanotube synthesis. They can be useful in any application of the foregoing reactions, including, but not limited to, in water purification.

The present disclosure describes the successful synthesis of LDO-supported cobalt nanoparticles from Co—Mg—Al hydrotalcite by thermal phase transformation. The disclosure shows that the catalytic reactivity of cobalt nanoparticles is greatly improved by affixing them on LDO nanodisks through heteroepitaxy to resist aggregation. Compared to cobalt nano-catalysts reported previously, LDO-Co exhibits at least 49 times increase in mass-normalized reactivity for catalyzing the reduction of p-nitrophenol by borohydride. This has greatly reduced the difference between the catalytic reactivity of cobalt and that of dendrimer-stabilized palladium, the previous best precious metal catalyst for p-nitrophenol reduction.

The present LDO-Co composition is herein shown to be a cost-effective solution in water purification (as evidenced in the catalytic reduction of p-nitrophenol with borohydride), in comparison to the most active precious metal catalyst made of palladium. This cost-effectiveness is achieved by affixing Co nanoparticles on two-dimensional layered double oxide (LDO) nanodisks through thermal phase transformation of cobalt-magnesium-aluminum layered double hydroxide precursors.

Compared to other Co nano-catalysts, the instant LDO-Co design has improved the reactivity of cobalt by at least 49 times. This disclosure shows that the instant LDO-Co surpasses all the cobalt-based catalysts reported so far in the literature in catalyzing the reduction of p-nitrophenol by borohydride, giving a relative reactivity ratio of LDO-Co with the most active dendrimer-stabilized Pd nano-catalysts exceeding the price ratio of cobalt and palladium. The current results indicate that economic incentives exist for replacing palladium with cobalt in similar applications. Furthermore, the high reactivity of LDO-Co retains with repeated use and is transferable when a more realistic hydrogen donor such as formate is used in place of borohydride.

### Chemical Elements

Herein, chemicals are referred to by their common abbreviations (chemical symbols), found on the Periodic Table of the Elements. Cobalt (chemical symbol Co) is a transition metal with an atomic number of 27. Palladium, Pd, has an atomic number of 46. Ordinarily skilled artisans will recognize additional chemical symbols and understand their plain meaning.

### Nano-

“Nano-” is a metric system unit prefix which means one billionth (ie, 1/1,000,000,000 or 10⁻⁹). As a prefix, nano- can be applied to lengths (eg, nanometer), or other freestanding words (eg, nanoparticle, nanodisk, nanocatalyst).

A nanodisk is a disk (also “disc”) which has at least one dimension on the nanoscale. For example, the height could be a nanoscale reading. As an alternative example, the diameter or radius of the disk could be on the nanoscale. As an alternative example, all of the height, radius and diameter could be on the nanoscale.

A nanoparticle is a particle which has at least one dimension on the nanoscale. A particle, including a nanoparticle, can have a regular shape, such as a sphere, cube or rectangular prism. In the case of a spherical nanoparticle, at least one dimension, such as a radius or diameter is on the nanoscale. In the case of a rectangularly prismic nanoparticle, a side of the prism is on the nanoscale. Alternatively, a particle, including a nanoparticle, can have an irregular shape. In an irregularly shaped nanoparticle, at least the smallest dimension of the particle is on the nanoscale.

A nanocatalyst is a catalyst which has at least one nanoscale dimension. The nanoscale dimension can be any external dimension (eg, length, width, height) or an internal dimension (eg, an internal structure).

### PNP

p-nitrophenol (PNP) is a Clean Water Act priority pollutant, which has an acceptable daily intake (ADI) of 0.32 mg per day over a month. The toxicity of p-nitrophenol can be lowered significantly after it is reduced to p-aminophenol, which has a negligible ADI of 4.55 mg per day over lifetime.

### Catalyst

A catalyst is a substance which increases the rate of a chemical reaction without itself being consumed by the reaction. Catalysis is the process of increasing the rate of a chemical reaction due to the presence of a catalyst. At a molecular level, reactions require a lower activation energy in the presence of a catalyst, and therefore begin more quickly. In a complex chemical reaction, having multiple steps, multiple catalysts can be used. A catalyst is defined by its function, rather than by its shape, size, or chemical composition.

A nano-catalyst (or “nanocatalyst”) is a catalyst which has at least one nanoscale dimension. The nanoscale dimension can be any external dimension (eg, length, width, height) or an internal dimension (eg, an internal structure). A nano-catalyst can be of any shape, including but not limited to a nanodisc, and a nanoparticle.

### EXAMPLES

The following non-limiting examples are provided to further illustrate the present disclosure. It will be appreciated by those of skill in the art that the techniques disclosed in the Examples represent at least exemplary, but not necessarily every, mode of practice of the described technologies. Those of skill in the art should, in light of the disclosure, appreciate that changes can be made in the specifically disclosed embodiments, without departing from the spirit and scope of the claimed invention.

Reagent-grade chemicals were purchased from Sigma Aldrich unless otherwise specified. Deionized (DI) water was generated on site using a Millipore system.

### Example 1

### Preparation and Characterization of LDO-Co

Urea (CO(NH₂)₂), aluminum nitrate (Al(NO₃)₃), magnesium nitrate (Mg(NO₃)₂), and cobalt nitrate (Co(NO₃)₂) were dissolved in 100 mL DI water, resulting in a urea concentration of 100 mM and a total metal concentration of 50 mM. The molar ratio of divalent magnesium and cobalt to trivalent aluminum was kept constant at 2:1. The molar percentage of cobalt with regard to all metals, θ, was varied from 0 to 67% (note: no Mg at θ=67%). LDH was synthesized in a sealed autoclave reactor at 100° C. in 12 h. LDH powder was collected by centrifugation, washed with DI water, and freeze-dried (Labconco Freezone 4.5).

The powder was then placed inside a sealed quartz tubing and heated in a tube furnace to 600° C. under argon protection. Hydrogen was introduced into the quartz tubing at 50 sccm for 20 min to carry out thermal phase transformation. LDH, LDO, and LDO-Co were characterized using transmission electron microscopy (TEM; FEI Titan 300-80), scanning electron microscopy (SEM; FEI Magellan 400), atomic force microscopy (AFM; Park Systems XE 70), and powder X-ray diffraction (XRD; Bruker D8 Advance Davinci). Sample preparation and analyses were made following standard procedures. Metal contents in LDO-Co was measured using inductively coupled plasma optical emission spectroscopy (ICP-OES; Perkin Elmer Optima 2000DV) after LDO-Co was completely digested in 70% nitric acid.

### Example 2

### Catalytic Reduction of p-Nitrophenol by Borohydride

A working suspension of LDO-Co was prepared by dispersing 2 mg LDO-Co in 8 mL DI water. The suspension was sonicated for 10 min to ensure complete dispersion. 0.75 mL working suspension was mixed with 32 mM NaBH₄ at a 1:1 volumetric ratio and shaken for 2 h to reduce any oxidized cobalt nanoparticles back to metallic cobalt. The mixture was then transferred into a standard UV/vis quartz cuvette. Another 1.5 mL NaBH₄ (32 mM) and 30 μL p-nitrophenol (20 mM) were added to the cuvette to initiate the p-nitrophenol reduction. The reaction solution was stirred with a small magnetic bar. The light absorption from 220 to 520 nm by the reactive solution was recorded every 30 seconds with a UV/vis spectrophotometer (Agilent Cary 300). A baseline absorbance was established using a 3-mL mixture consisting of LDO-Co and NaBH₄ but not p-nitrophenol. After subtracting the baseline, absorbance was converted to concentration using a calibration curve obtained with p-nitrophenol solutions of known concentrations.

### Example 3

### Co Nanoparticles Loosely Attached to LDO (LDO-Co*)

LDO-Co* was prepared in two steps. First, 20 mg LDO (0=0) and 46.5 mg Co(NO₃)₂.9H₂O were added to 10 mL DI water under 10-min sonication and mixed on a shaking table for 24 h. LDO nanodisks with adsorbed Co²⁺ were then collected by centrifugation, washed with DI water for three times and freeze-dried. Second, 12.5 mg LDO adsorbed with Co²⁺ was dispersed in 10 mL 32 mM NaBH₄ solution to reduce Co²⁺ to metallic Co. After 2 h, LDO-Co* was collected by centrifugation and used to catalyze the reduction of p-nitrophenol by borohydride. To do so, 1.5 mL suspension containing 1.25 g L LDO-Co* was mixed with 1.5 mL NaBH₄ (32 mM) and 30 μL PNP (20 mM) in a quartz cuvette.

### 2.3. Example 4

### Catalytic Reduction of p-Nitrophenol by Formate

The reaction was conducted in a 50-mL 3-neck flask immersed in water, which isolated contents inside the flask from air. 5 mg LDO-Co with θ=28(±2)% was dispersed in 18.5 mL DI water by sonication and transferred into the flask. The solution was purged by N₂ at a flow rate of 60 sccm and mixed by a magnetic stir bar. The gas was released from the flask into air through a thin tubing. After 2 hr, 1 mL DI water containing 10 mg NaBH₄ was added to reduce oxidized cobalt into metallic cobalt. After another 2 h, a mixture of 0.5 mL sodium formate (HCOONa, 2.0 M) and p-nitrophenol (8.0 mM) was injected into the flask to start the reaction. A control experiment was performed following the same protocol without adding sodium formate.

### Example 5

### Synthesis and Characterization of LDO-Co

Cobalt nanoparticles supported on layered double oxide nanodisks were prepared by thermal phase transformation, involving two critical steps as illustrated in FIG. 1a. First, layered double hydroxide nanodisks containing Co were synthesized by the hydrothermal reaction of cobalt, magnesium, and aluminum nitrates with urea. The hexagonal LDH nanodisks were approximately 4 μm in size and 45 nm in thickness, as shown in FIGS. 1b and c. Second, LDH was annealed at 600° C. in hydrogen, creating nanoparticles affixed on the nanodisks' surface, as shown in FIG. 1d and e. AFM measurements, as illustrated in FIG. 1d, showed that the nanoparticles have heights comparable to their diameters, suggesting that the nanoparticles are pseudo-spherical. TEM revealed voids inside the nanodisks, as marked in FIG. 1e, possibly formed by the loss of water and intercalated carbonic acid during annealing (cf. Figure S1 for no voids in LDH). XRD confirmed that LDH has a hydrotalcite structure, as shown in FIG. 1f. The XRD peaks for LDH were sharp, suggesting a LDH crystal can be as large as a single disk with micrometers in size. XRD also revealed that annealing transforms LDH to a spinel oxide structure while the nanodisks' platy morphology is preserved. The wide XRD peaks observed for LDO confirmed that LDO was made of nanometer-sized crystallites, consistent with the presence of nanometer-sized voids inside the platy nanodisks. The voids had hexagonal shapes, consistent with the closely packed lattices of brucite planes in hydrotalcite. For LDO-Co, cobalt nanoparticles represented a minority component and thus were not resolved by XRD. We further investigated the morphology and phases of LDO-Co using high-resolution TEM. Three crystalline phases, Co-HCP, Co₃O₄ and MgAl₂O₄ were identified in the samples. Cobalt oxide was formed when LDO-Co is removed from the reducing environment where it was synthesized under argon protection. The oxidation of cobalt transition metal nanoparticles in the air is not exceptional because most transition metal nanoparticles except those of noble metals are readily oxidized when they are exposed to air. In practice, oxidation is not expected to be an issue when LDO-Co is continuously used in a reducing environment. When cobalt is oxidized due to exposure to an oxidizing environment such as the air, it can be readily reduced back to the metallic state using agents such as borohydride.

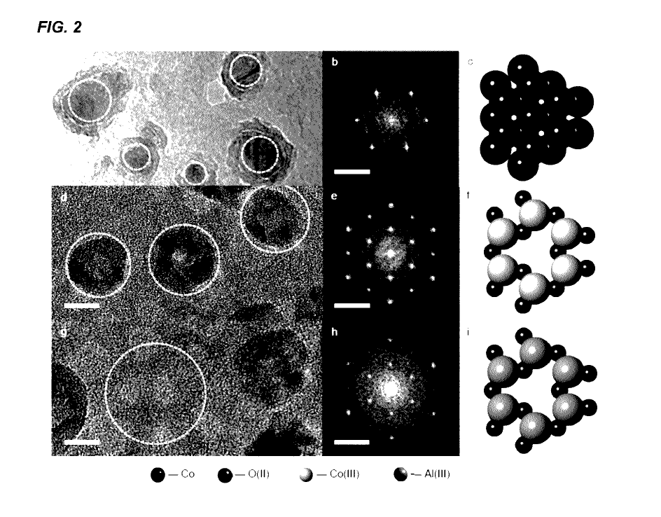

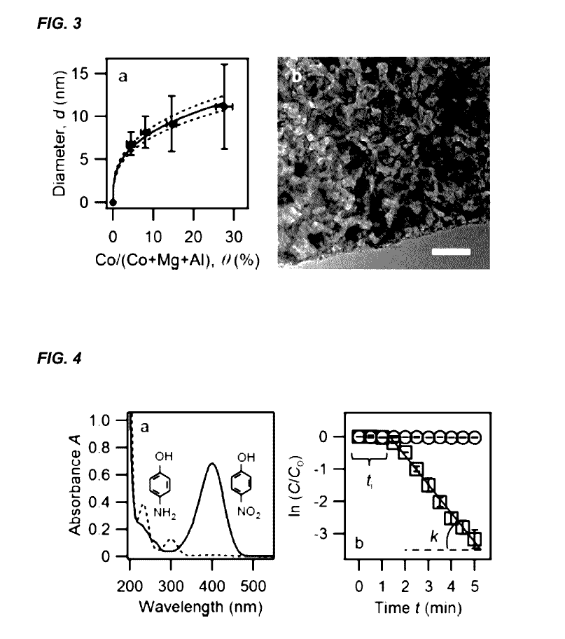

As shown in FIG. 2a-c, Co nanoparticles exposed in the air for half an hour between sample preparation and examination had a core-shell structure. Fast Fourier transform (FFT) of the TEM revealed that the cobalt core had a hexagonal close packing (HCP) structure, consistent with the phase diagram of cobalt under 600° C. With LDO-Co lying flat on the TEM grid, Co-HCP was viewed in the [001] direction, suggesting that the closely packed {001} plane of Co-HCP was in parallel with the LDO surface. The shell consisted of Co oxides as a result of accelerated oxidation of Co nanoparticles at the nanometer scale according to the Cabrera-Mott mechanism. After being exposed in the air for 2 days, the nanoparticles were completely oxidized to cobalt oxide Co₃O₄, as shown in FIG. 2d f. The identification of Co₃O₄ was facilitated by FFT, showing a spinel structure viewed along the [111] zone axis. This orientation also suggested that the closely packed {111} plane of Co₃O₄ is parallel to the LDO surface. Similar to Co₃O₄, LDO also had a spinel structure, shown in FIG. 2g-i. The FFT pattern of LDO further showed that from the top, LDO was viewed along the [111] zone axis, indicating that its surface is formed by the closely packed {111} plane. We measured the diameter dₒ of completely oxidized nanoparticles and estimated the diameter d of cobalt nanoparticles by assuming the elimination of all oxygen after borohydride reduction (i.e., d=0.51dₒ). For each sample, measurements showed that the values of d are normally distributed (Figure S3), which can be represented by the mean in combination with the standard deviation. With cobalt molar percentage θ=0 to 28(±2)% as measured by ICP-OES after acid digestion, d can be varied from 0 to 11.1(±4.9) nm (standard deviation in parentheses), as shown in FIG. 3a. The increase of d with θ was found to follow d=3.8(±0.1)θ^{1/3} (R²=0.99), suggesting that the nanoparticles had increased in size but not in density. However, at θ>28(±2)%, the boundaries between nanoparticles were no longer discernible, as shown in FIG. 3b, suggesting the formation of a continuous cobalt film.

### Example 6

### Reactivity of LDO-Co in Catalyzing p-Nitrophenol Reduction by Borohydride

We demonstrated the high catalytic reactivity of LDO-Co using the model reaction of p-nitrophenol reduction by borohydride. This reaction was selected partly because of its well-understood reaction mechanism and easy-to-follow kinetics. In the presence of metal catalysts, the nitro group of p-nitrophenol was transformed to the amino group by borohydride, as shown in FIG. 4a. The change of p-nitrophenol concentration was quantified using the absorbance at 400 nm according to Beer's law.

To ensure all the nanoparticles were in the metallic state, LDO-Co was reacted with borohydride for 2 h before being used for catalysis. After 2 h, an excess amount of borohydride (final concentration: 16 mM) was added together with p-nitrophenol (0.2 mM) to initiate the catalyzed reduction. The excess amount of borohydride was used to facilitate comparisons of LDO-Co reactivity with the reactivities of other cobalt and palladium-based catalysts measured under similar conditions. It is worth noting that the mechanism of catalyzed reduction of p-nitrophenol by borohydride, including the dependence of reaction kinetics on borohydride concentration, is well understood.

Once p-nitrophenol was mixed with LDO-Co and an excess amount of borohydride, its concentration began to decrease rapidly. As shown by the squares in FIG. 4b, p-nitrophenol reduction conformed to a pseudo first order rate law after an induction period tᵢ:

ln(C/Cₒ)=−k(t−tᵢ) (1)

where Cₒ and C are initial and residual p-nitrophenol concentrations, t is the reaction time, and k is the rate constant. In comparison, ln(C/Cₒ) did not show discernible change with t when borohydride is added in the absence of LDO-Co (circles in FIG. 4b). k and tᵢ were estimated from the intercept and slope of the linearity between ln(C/Cₒ) and t−tᵢ. A linear correlation was observed between k and the concentration of LDO-Co, confirming that the reaction was not limited by mass transfer.

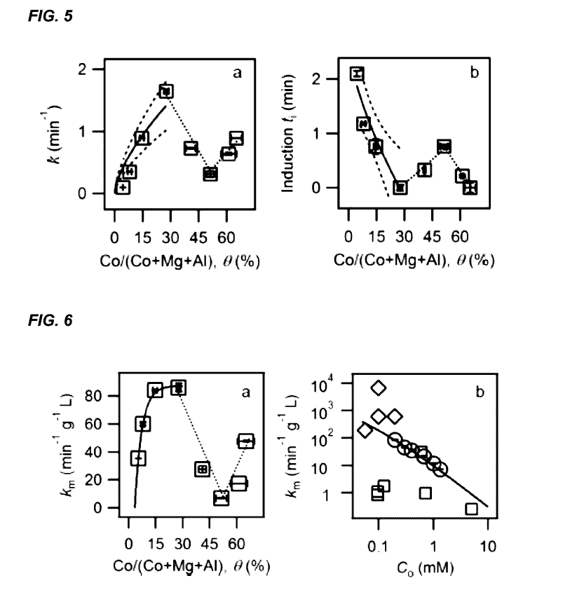

k showed a complex relationship with θ, as depicted in FIG. 5a. For 0≦θ≦28%, k increased monotonically with θ, following a linear correlation between k and θ^{2/3} (R²=0.95). At θ=0, a negligible value of k=0.003(±0.001) min⁻¹ was estimated from the control sample shown by the circles in FIG. 4b, Considering that d increased with θ^{1/3} (FIG. 3a), the correlation between k and θ^{2/3} suggested that the increase of total surface area is responsible for the increase of k in this θ range. As θ further increased, k decreased corresponding to the formation of a continuous cobalt film (cf. FIG. 3b), which eliminated most of the reactive edge and corner sites and thus reduced the overall catalytic reactivity of LDO-Co. Further increase of θ from 51% to 67% led to an increase of k, possibly due to the formation of new nanoparticles on top of the continuous film.

The relationship between tᵢ and θ exhibited a complete inversion of the k−θ relationship, as shown in FIG. 5b. This relationship can be explained by considering the adsorption of p-nitrophenol and borohydride at the beginning of the reaction. It is well established that the catalytic reduction of p-nitrophenol by borohydride follows the Langmuir-Hinshelwood mechanism, which involves two steps, including (1) dissociative adsorption of both reactants on the catalyst surface and (2) reaction between adsorbed species. Since LDO-Co had been in contact with borohydride for 2 h before the addition of p-nitrophenol, the species controlling reaction kinetics was p-nitrophenol. At the beginning of the reaction, the surface concentration of p-nitrophenol was increased from zero to the steady-state concentration through adsorption. This process takes time, as reflected by the presence of tᵢ. According to the Langmuir kinetics, tᵢ was inversely related to the catalyst's total surface area or d² for LDO-Co. Since d∝θ^{1/3}, we expected tᵢ∝θ^{2/3} for 0≦θ≦28%, as shown in FIG. 5b. As θ increased to 51% and then to 67%, tᵢ first increased and then decreased, following the inverse trends of surface area change.

### Example 7

### Comparisons with Previous Co and Pd Nano-Catalysts

FIG. 6a shows the dependence of LDO-Co reactivity on θ after k was normalized to the cobalt loading of LDO-Co. The maximum mass-normalized rate constant kₘ was found with θ=28% at kₘ=86(±3) min⁻¹ g⁻¹ L for Cₒ=0.2 mM. According to a semi-empirical Langmuir-Hinshelwood model, kₘ was a function of the initial PNP concentration Cₒ:

$${k}_{m} = \frac{{k}_{r \times n} {SK}_{PNP} {K}_{{BH}_{4}^{-}} {C}_{{BH}_{4}^{-}}}{{{C}_{o}^{0.4} ( 1 + {K}_{PNP}^{0.6} + {K}_{{BH}_{4}^{-}} {C}_{{BH}_{4}^{-}} )}^{2}} \qquad ( 2 )$$

where kᵣₓₙ was the reaction rate constant for adsorbed p-nitrophenol and borohydride, S was the active site density, K_{PNP} and K_{BH4-} were adsorption constants for p-nitrophenol (PNP) and borohydride, respectively, and C_{BH4-} is the concentration of borohydride. Indeed, we observed a decrease of kₘ with increasing co due to the increasing competition of p-nitrophenol with borohydride for adsorption, as shown by the circles and solid curve in FIG. 6b.

In comparison to suspended cobalt nano-catalysts and cobalt nanoparticles supported on reduced graphene oxide and hydrogel, LDO-Co exhibited a clear improvement in catalytic activity. For measurements made with an initial p-nitrophenol concentration of 0.1-0.2 mM, the reactivity of LDO-Co showed 49 times improvement compared to the highest reactivity obtained with previously reported Co nano-catalysts (i.e., Co(OH)₂ nanosheets). At Cₒ=0.6 mM, cobalt nanoparticles secured in silica cages (Co@SiO₂) showed similar reactivity as LDO-Co, as marked by the square near to the solid curve in FIG. 6. However, the reactivity of Co@SiO₂ deteriorated rapidly with reuse whereas the reactivity of LDO-Co remained unchanged with reuse (see below). In addition, the reactivity of LDO-Co surpassed the reactivities of Co-based alloys (highest reported rate: 6.4 min⁻¹ g⁻¹ L).

Compared to the highly reactive dendrimer-stabilized Pd catalyst (the highest diamond in FIG. 6), LDO-Co gave a relative reactivity ratio of kₘ(LDO-Co)/kₘ(dendrimer-Pd)=1:80. This ratio was 9.3 times the price ratio of 1:750 between cobalt and palladium. The direct comparison of catalyst reactivity and metal price was certainly an oversimplification regarding the costs of catalytic water treatment.

### Example 8

### Stability of LDO-Co in Reuse

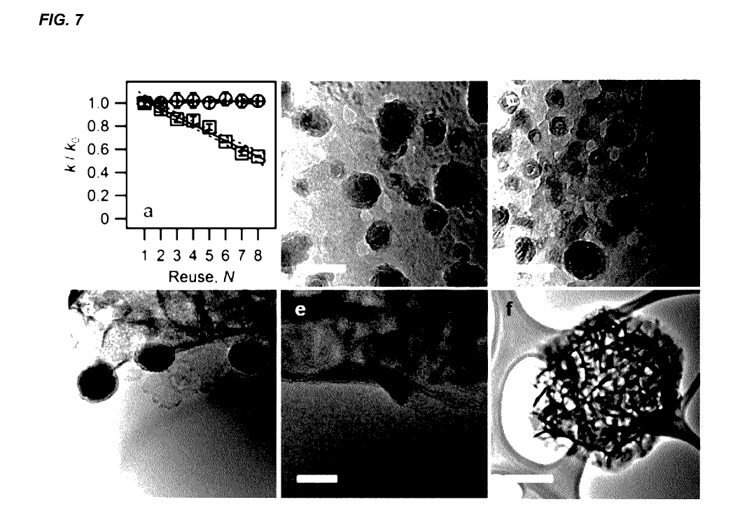

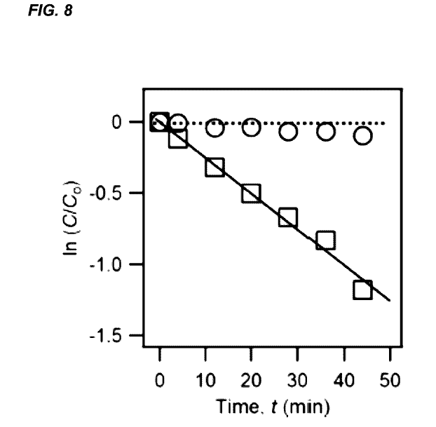

To investigate the longevity of LDO-Co during extended use, LDO-Co nanodisks were separated at the end of an experiment using magnetic attraction. The collected LDO-Co were then re-dispersed in a mixture of p-nitrophenol and borohydride to be evaluated for reuse. As shown in FIG. 7a, the ratio of k obtained in each reuse to the rate constant obtained with the pristine sample (k/k₀) varied little with repeated use, confirming the successful prevention of nanoparticle aggregation by affixing cobalt nanoparticles on LDO. This was consistent with comparisons made by TEM before and after reaction, as shown in FIGS. 7b and c, revealing that nanoparticles were similarly distributed on the LDO surface with no discernible aggregation. In addition to the stability of cobalt nanoparticles, the LDO support was also structurally stable, as evident from the similar XRD spectra measured before and after reaction.

We propose that the affixation of cobalt nanoparticles on LDO by thermal phase transformation is essential for the longevity of LDO-Co. To examine this hypothesis, we have synthesized a control sample with Co nanoparticles only loosely attached to the LDO surface, which we refer to as LDO-Co*. LDO-Co* was synthesized by adsorbing Co²⁺ on LDO from an aqueous solution and reducing it to metallic cobalt in a borohydride solution. As shown in FIG. 7d, this method produced cobalt nanoparticles having diameters around 37(±6) nm. In addition to the size difference, most of the nanoparticles in LDO-Co* were attached to the edges of LDO nanodisks in contrast to the nanoparticles well-dispersed on LDO-Co surfaces. The cobalt content in LDO-Co* was estimated at 16.2% by ICP-OES after acid digestion.

When pristine LDO-Co* was used to catalyze the reduction of p-nitrophenol by borohydride, a pseudo first order rate law was also observed, giving a rate constant of k₀=9.4 min⁻¹ g⁻¹ L. This value was approximately an order of magnitude lower than that for LDO-Co with the same cobalt content (i.e., θ=16.2%). The reduced reactivity was attributed to the large size of cobalt nanoparticles in LDO-Co* compared to those in LDO-Co (37 vs 9.7 nm, respectively). In addition, the reactivity of LDO-Co* decreased linearly after repeated use, as shown by the squares in FIG. 7a. The decrease of k followed a reduction rate of 7(±1)% per use and reached 46% after the 8^{th} use. TEM examination of LDO-Co* after reuse revealed that few cobalt nanoparticles could still be found on LDO, as shown in FIGS. 7e and f, suggesting that the loosely attached nanoparticles had fallen off the support and possibly have aggregated in solution.

### Example 9

### Catalytic Activity of LDO-Co with Formate as Hydrogen Donor

Although sodium borohydride has been widely used in both scientific investigations and industrial applications, the application of borohydride in remediation is still challenging. As a strong reductant, borohydride reacts with water in the absence of catalysts, although much slower, and thus can lose reactivity over time. The use of borohydride introduces boron, in the form of borate as the oxidation product of borohydride, into the receiving water body, which may pose health concerns. In comparison, formate is a moderate reductant and hydrogen donor. Formate has been shown to reduce nitrophenol under the catalysis of palladium; however, the reduction of nitrophenol by formate has not been investigated for non-precious metal catalysts including cobalt.

To investigate whether LDO-Co can catalyze the reduction of p-nitrophenol by formate, we measured the change of p-nitrophenol concentration in a mixture with sodium formate with and without LDO-Co. As shown in FIG. 8, the reduction of p-nitrophenol by formate had a negligible rate in the absence of LDO-Co. In the presence of LDO-Co, the reduction followed a pseudo first order rate law. The rate constant was estimated at k=0.36 (±0.01) min⁻¹ g⁻¹ L with LDO-Co concentration of 0.1 g L⁻¹, an initial p-nitrophenol concentration of 0.2 mM, and an initial formate concentration of 50 mM (only 3.125 times the typical borohydride concentration). Although this rate constant was 239 times smaller than the rate constant obtained using borohydride, it should be considered evidence of LDO-Co being highly reactive with formate as the hydrogen donor because it gives a relative reactivity ratio of 1:13 with palladium.

### Example 10

### Structure of the LDO-Co Nanoparticles

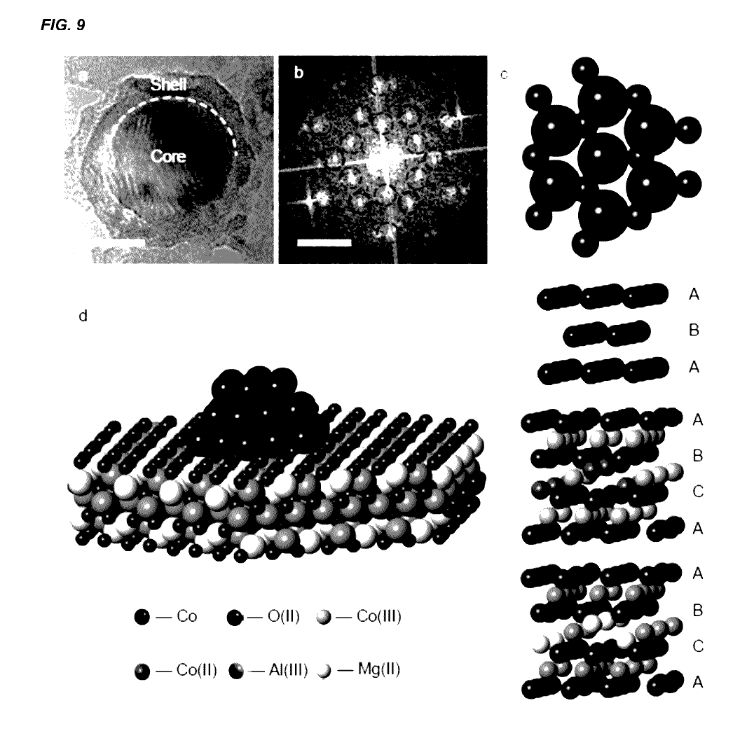

The current results showed that cobalt nanoparticles synthesized by thermal phase transformation are tightly fixed on LDO supports. The immobilization of cobalt nanoparticles is essential for their initial and sustained high reactivity in catalysis. Because cobalt is readily oxidized by oxygen in the air, nanoparticles supported on LDO are observed as a Co@Co₃O₄ core-shell structure. A comprehensive survey of the LDO-Co samples prepared in this study revealed that Co@Co₃O₄ nanoparticles are not randomly stacked on top of the LDO surface. As shown in FIG. 9a-c, the FFT of the core-shell gave two sets of electron diffraction patterns that match exactly those of Co-HCP and MgAl₂O₄ (cf. FIGS. 2b and h). The direction perpendicular to the LDO surface overlapped with the [001] zone axis of Co-HCP and the [111] zone axis of MgAl₂O₄, suggesting that within the surface plane, Co-HCP [010] is aligned with MgAl₂O₄ [011] (i.e., the direction pointing upward). Since there is no unassigned diffraction spot left, the pattern created by Co₃O₄ must have overlapped with the pattern created by spinel LDO.

The deconvolution of the FFT patterns generated by LDO-supported Co@Co₃O₄ suggested that the nanoparticles are affixed on LDO by heteroepitaxy. As shown in FIG. 9d, the structure of Co-HCP could be viewed as the stacking of two {001} layers of closely packed Co atoms (marked as A and B). The spinel structures of Co₃O₄ and MgAl₂O₄ could be envisioned as the stacking of three different layers of cubic-close packed O anions (marked as A, B, and C). Oxygen atoms in A and B layers formed octahedrons with centers occupied by Co(III) cations. Oxygen atoms in B and C layers formed alternating octahedrons and tetrahedrons with centers occupied by Co(III) and Co(II) cations, respectively. The unique orientations of Co-HCP and LDO, as elucidated in FIG. 9a-c, placed six out of every seven hexagonally packed cobalt atoms in the {001} facet on top of the O atoms in the {111} facet of MgAl₂O₄. Each of the six cobalt atoms could have then formed three Co—O bonds with the underlying O atoms similar to Co(III) in Co₃O₄.

The hypothesis that Co@Co₃O₄ nanoparticles are affixed on LDO through heteroepitaxy was supported by the similarity between the length of Co—Co bonds in Co-HCP and the length of Co(III)-Co(III) bonds in Co₃O₄. For bulk Co-HCP, the Co—Co bond had a length of 0.251 nm. In comparison, the length of Co(III)-Co(III) in Co₃O₄ was 0.286 nm, suggesting that Co—Co bonds in Co-HCP only needed to stretch 14% to replace Co(III) on the surface of LDO. Similar degrees of mismatch have been observed on the heteroepitaxial growth of FeO(111) and Fe₃O₄(111) on Pt(111); therefore, the degree of bond stretching required for the formation interfacial Co(III)-O bonds between Co-HCP and LDO was reasonable and should not lead to the disintegration of cobalt nanoparticles. On the contrary, the lateral stretching of Co—Co distance may have assisted the accommodation of the seventh cobalt atom located in the center of the hexagon that is not bonded to LDO oxygen underneath. Although we could not perform microscopic examination of the supported nanoparticles in the pure metallic state due to the oxidation of metallic cobalt by oxygen in the air, the unfaltering reactivity of LDO-Co in reuse suggests that the interfacial Co—O bonds were intact even after Co₃O₄ was reduced to Co-HCP by borohydride.

To catalyze reductive reactions, transition metal nanoparticles that had been oxidized by ambient oxygen needed to be reduced back to the metallic state for activation. For LDO-Co, the reductive activation can have been performed by borohydride in situ. Although the reduction potential of Co₃O₄ to metallic Co has not been reported, the fact that Co could be oxidized under the ambient condition suggested that E(Co₃O₄/Co)<E(O₂/H₂O; pH 7)=0.82 V. Borohydride was a potent reductant with a potential of E(BO⁻/BH⁻)<−1.0 V under our experimental conditions (i.e., ca. pH 10-11). The presence of Co core observed under TEM supported the reduction of Co₃O₄ to metallic Co by borohydride (cf. FIG. 2). Previously, cobalt boride (Co₂B) was claimed as a product of the reduction of Co₃O₄ by borohydride; however, it has been contended that the sole experimental evidence obtained from XRD was insufficient to support the identification of the boride phase. In our analyses, we find no evidence suggesting the formation of cobalt boride. Whether boron is present at the surface of LDO-Co during the reduction of PNP is, however, beyond the scope of this study.

What is claimed is:

1. A method of making layered double oxide (LDO) particles comprising:
reacting a solution comprising cobalt with layered double hydroxide (LDH).

2. The method of claim 1, wherein the cobalt in the solution comprising cobalt is provided as cobalt nitrate (Co(NO₃)₂).

3. The method of claim 2, wherein the solution comprising cobalt further comprises at least one of urea (CO(NH₂)₂), aluminum nitrate (Al(NO₃)₃), and magnesium nitrate (Mg(NO₃)₂).

4. The method of claim 3, wherein the cobalt nitrate, aluminum nitrate, and magnesium nitrate are provided at a molar ratio of 2 magnesium nitrate:2 cobalt nitrate:1 aluminum nitrate.

5. The method of claim 1, wherein the reacting comprises placing the solution comprising cobalt in a sealed container with LDH.

6. The method of claim 1, wherein the reacting comprises heating the solution comprising cobalt and LDH to a temperature of 600° C.

7. The method of claim 6, wherein the heating the solution takes place under an inert atmosphere.

8. The method of claim 7, wherein the inert atmosphere is argon gas.

9. The method of claim 5, wherein the sealed container is a quartz tube.

10. The method of claim 1, wherein the reacting comprises thermal phase transformation.

11. The method of claim 10, wherein the thermal phase transformation takes place under a hydrogen gas atmosphere.

12. The method of claim 11, wherein the hydrogen gas atmosphere is introduced at a rate of 50 sccm.

13. The method of claim 10, wherein the thermal phase transformation is allowed to proceed for about 20 minutes.

14. The method of claim 3, wherein the molar percentage of cobalt relative to all metals (Θ) is between 0.1 and 67%.

15. The method of claim 14, wherein Θ is about 28%.

16. A method of purifying water comprising:
contacting layered double oxide (LDO) comprising cobalt (LDO-Co) with p-nitrophenol (PNP).

17. The method of claim 16, further comprising mixing the LDO-Co with sodium borohydride (NaBH₄).

18. The method of claim 16, comprising reducing oxidized LDO-Co to metallic cobalt.

19. The method of claim 16, wherein at least one of the LDO-Co and the PNP are suspended in water.
